(19) United States
(12) Patent Application Publication
(10) Pub. No.: US 2026/0117735 A1
(43) Pub. Date: Apr. 30, 2026

(54) SYSTEM FOR ENERGY STORAGE BY FLUID COMPRESSION AND CONCENTRATION DIFFERENCE IN A LIQUID SOLUTION

(71) Applicant: Edgar GALVÁN MARTÍNEZ, General Escobedo, Nuevo León (MX)

(72) Inventor: Edgar GALVÁN MARTÍNEZ, General Escobedo, Nuevo León (MX)

(21) Appl. No.: 19/144,155

(22) PCT Filed: Mar. 15, 2024
(86) PCT No.: PCT/MX2024/050018

§ 371 Date: Jun. 27, 2025

(30) Foreign Application Priority Data
Mar. 17, 2023 (MX) MX/A/2023/003213

(51) Int. Cl. F03B 13/00; B01D 61/02

(52) U.S. Cl. CPC F03B 13/00; B01D 61/025; B01D 2313/243; B01D 2313/501; F05B 2220/706

(57) ABSTRACT

A system that provides energy storage using flow driven by a difference in the concentration of a solution comprising a solvent and a solute. There are several options for solvent and solute, with the most economical being water and salts, respectively. The system for the storage of energy by fluid compression and concentration difference in a liquid solution is characterized by having a charging stage in which energy is stored and a discharging stage in which this energy is released. The system comprises a pump, a semi-permeable separator, three reservoirs, one of which is pressurized, and a turbine coupled to an electric power generator, in which, during the discharging stage, the system is able to release the energy that was stored during the charging stage.

### FIELD OF THE INVENTION

The present invention relates to energy storage. Renewable energy systems are considered essential technologies that can replace current fossil fuel-based power generation systems. However, the intermittency of these renewable sources, especially wind and solar, creates an obstacle for renewable sources to be a viable option as providers for electrical grids. Therefore, systems that can store large amounts of energy are necessary to enable lower-carbon electricity generation.

Currently, batteries are the most common energy storage option for residential and commercial buildings. Unfortunately, repeated cycles degrade their storage capacity, resulting in a short lifespan, which increases the ecological footprint during production and final disposal. Furthermore, batteries add fire risks to energy storage facilities. Therefore, it is needed to have alternative energy storage options without these drawbacks.

### BACKGROUND OF THE INVENTION

Pumped storage hydropower (commonly known as PSH) utilizes the difference in height between two water reservoirs to store potential energy that later can be utilized to drive a turbine, releasing the stored energy when needed. PSH is a mature technology with relatively high round-trip efficiency. However, their use is limited due to the obvious geographical restrictions in order to have the required difference in height between both water reservoirs.

Another way to store energy is to use electrical energy to compress air and store it in large reservoirs. During a high demand for electrical power, compressed air is released and used to produce electrical power through the use of a turbine. These are called compressed air energy storage systems (commonly known as CAES). However, due to compressor losses, the efficiency is low for conventional CAES systems. This can be improved by storing some of the thermal energy released during compression and then using it during the expansion stage.

There is also a combination of PSH and CAES in the state of the art. In such a system, during low energy demand, the energy is utilized to pump a liquid (charging stage) that finally compresses the gas inside a pressurized vessel. When the power is needed, a valve is opened in order to send the liquid to a turbine connected to an electric generator (discharging stage). In this way, the pressure in the vessel decreases until the pressure is so low that it cannot produce more energy in the generator. At this point, the system is ready to start the charging stage again.

The efficiency of this system can be increased by using a phase-changing fluid in the system's operating range, allowing energy to be stored not only by compression but also by phase change.

The main cost of these systems is related to the manufacture of the pressurized vessels. This is due to an intrinsic characteristic of the process: all energy is stored in the form of pressure. Consequently, the vessels must be of considerable thickness to be able to withstand very high pressures, increasing the cost of such vessels. Hence, in recent years efforts have been made to reduce the cost of these containers.

Unlike the state of the art, the present invention stores energy not only in the form of pressure from a compressible fluid but also in the form of chemical potential from a liquid solution comprising a solvent and a solute. This is carried out by pumping the liquid solution from reservoir A to a pressurized reservoir B, which in turn is connected to a semipermeable separator capable of being used in osmosis processes, allowing the transfer of solvent to reservoir C at low pressure by reverse osmosis, but at the same time avoiding the transfer of the solute, which is stored in pressurized reservoir B in the form of an aqueous solution. As the volume of the aqueous solution in reservoir B increases, the volume occupied by the compressible fluid decreases, increasing the pressure of the entire reservoir B and the equipment connected to it. This allows that at the end of the charging stage, the energy is stored not only in the form of pressure within reservoir B, but also in the form of chemical potential when separating the solute from the solvent in the semipermeable separator. Once the discharging stage begins, the pressure of the pressurized vessel begins to decrease, reaching a point where the solvent passes from the low-pressure reservoir C to the pressurized reservoir B by osmosis through the semipermeable separator. This increases the energy storage capacity for a given volume and pressure of pressurized tanks compared with the state of the art.

### DETAILED DESCRIPTION OF THE INVENTION

The present invention comprises and enables a system that provides enhanced energy storage using flow driven by a difference in concentration of a solution comprising a solvent and a solute. Water can be used as a solvent. The solute can be a salt or some other compound that is dissolved in the solvent. In addition to the solution, the system also uses a compressible fluid that can be air. The invention comprises a turbine coupled to an electricity generator, an electric pump, several valves, a semipermeable separator which have membranes that allow the passage of a solvent but prevent the passage of the solute, at least one reservoir A to store a liquid solution at low pressure, at least one reservoir B to store both the compressible fluid and a part of the solution, at least one reservoir C to store the solvent separated by the semipermeable separator, a set of pipes to interconnect the equipment, as well as an instrumentation and automatic process control system.

This technical report describes the operation of the particular case in which there is one reservoir A, one reservoir B and one reservoir C, with the understanding that this description is applicable to a greater number of reservoirs.

For the purpose of simplifying the explanation of the invention, the section of the system that is at high pressure with respect to the rest will be called the pressurized section (FIG. 5), which is comprised of reservoir B, the pressurized cavity of the semipermeable separator and the connecting pipes with the pump and the turbine. Likewise, in the description of the system, 5 valves are mentioned for illustrative purposes of the flow direction in the system during the different stages of the process. However, the invention is not limited to just this particular number of valves. All of the valves shown in the figures are bidirectional valves.

In order to store energy and transform it into electricity when required, the present invention comprises several stages, which are shown in the pressure-concentration diagram in FIG. 4 and explained below.

At the beginning of the charging stage (point A of FIG. 4) reservoir A contains a low-pressure liquid solution (which may be atmospheric) comprising the solvent (which may be water) and at least one solute that can be a salt or some other compound that is dissolved in the solvent. Reservoir A has a connection pipe in order to connect to the valve V1 and to the pump. This connection must be below the liquid level in reservoir A (see FIG. 6) to ensure that the pump only pulls liquid.

Reservoir B contains in its upper part a compressible fluid (it can be air) of lower density than the liquid solution. The compressible fluid is kept contained in reservoir B during all process stages due to the lower density compared to the liquid solution. The connection of the outlet pipe connecting reservoir B to valve V4 must be located in such a way that it ensures that the liquid level in reservoir B is always above this outlet pipe connection to maximize the amount of liquid during the discharging stage. Reservoir C is at low pressure, which may be atmospheric pressure. This reservoir C is connected to a semipermeable separator, for example, a semipermeable membrane such as those utilized in reverse osmosis systems, which allows the flow of the solvent, but prevents the flow of solutes. The pipe connection in reservoir C should be located in such a way to ensure that the liquid level within the reservoir is always above the reservoir connection (see FIG. 8).

The charging stage of the system is represented by segment A-B in FIG. 4. During this stage, electrical energy generated by renewable energy sources is utilized for powering the pump, sending the aqueous solution from reservoir A to the pressurized system, and thus compressing the compressible fluid contained in reservoir B.

This compression means that pressure increases within the pressurized system, including the compressible fluid and the aqueous solution. As the pressure increases, the difference between the pressure and the osmotic pressure of the solution also increases, allowing the solvent (it can be water) to pass through the semipermeable separator into the reservoir C but keeping the solute in the pressurized system solution. Therefore, the solute concentration in the pressurized system increases during the charging stage. This can be clearly represented by segment A-B in FIG. 4.

Throughout the charging stage, energy is stored not only due to the increased pressure of the pressurized system, but also due to the increase in the chemical potential of the solution due to the separation of the solute. That is, during the charging stage, the reverse osmosis process occurs, whereby the solvent passes through the semipermeable separator, forming 2 solutions with different solute concentration: a concentrated solution of solute within the pressurized system and a much less concentrated solution (i.e., diluted) in reservoir C. This difference in concentration between the two solutions is the cause that, during discharging stage, the solvent is transferred from a low-pressure system to a higher-pressure system through the semi-permeable separator due to the osmosis process. In this way, during the charging stage a part of the electrical energy is converted to fluid energy in the form of pressure in the pump and then stored in the form of chemical potential by separating the solution in the semi-permeable separator. During the discharging stage, this energy in the form of chemical potential is converted back to fluid energy in the form of pressure as it passes through the semipermeable separator, and then back to electrical energy as it passes through the turbine that drives an electric power generator.

The pressurized system is provided with at least one pressure sensor that detects the operating pressure and automatically stops the introduction of further solution into the pressurized system once the maximum permissible pressure of the pressurized system has been reached. In the diagram shown in FIG. 1 this is represented by closing the valve V2 and stopping the pump. At that time, the volume of liquid in reservoir C may be several times greater than the volume in reservoir B. Thus, the volume of the energy storage liquid is maximized. Since reservoir B is the only one that has to withstand high pressures, the total cost of the system is reduced.

The segment B-C in FIG. 4 represents the period immediately following the charging stage. When the solution pumping stops at the end of the charging stage, the pressure of the pressurized system is greater than the osmotic pressure of the solution, therefore, a part of the solvent tends to naturally pass into the reservoir C, slightly depressurizing the pressurized system until the osmotic equilibrium is reached. At the end of this stage, the system is ready to generate electricity when required.

The C-D segment in FIG. 4 corresponds to the discharging stage of the system, during which the liquid solution contained in reservoir B is conducted to a turbine coupled to an electric power generator to release its energy. In the diagram shown in FIG. 2 this is represented by opening the valves V4 and V5.

During the discharging stage, as the volume of aqueous solution in the pressurized system decreases, the pressure drops below the osmotic pressure of the solution, allowing the solvent to pass through the semipermeable membrane from reservoir C into the pressurized system. In this way, the volume of the liquid that was at low pressure in reservoir C can now be utilized in the generation of electrical power, increasing the total capacity of the pressurized system.

After passing through the turbine, the liquid solution is discharged into a reservoir that may or may not be the same reservoir A that was utilized during the charging stage. The start of the discharging stage can be automatized according to the requirements of the electrical network or according to the action of an operator. In the specific case of the configuration shown in FIG. 2 in which the same reservoir A utilized in the charging stage is used in the discharging stage, valves V4 and V5 remain open to connect reservoir B with the semi-permeable separator and with the turbine and reservoir A. The valve V2 remains closed to isolate the pump. Once the pressure sensor of the pressurized system detects that the minimum pressure required by the turbine has been reached or that the minimum level of the solution in reservoir B has been reached, the delivery of liquid solution to the turbine is automatically stopped. In the diagram shown in FIG. 2 this is represented by closing the valve V5.

The segment D-A in FIG. 4 represents the period immediately following the discharging stage. When the solution is stopped at the end of the discharging stage, the pressure of the pressurized system is lower than the osmotic pressure of the solution, therefore, a part of the solvent tends to pass naturally from reservoir C into the pressurized system, slightly increasing the pressure of the pressurized system until the osmotic equilibrium is reached. At the end of this stage, the system is ready for the next charging stage.

The duration of the charging and discharging stages depends on the size of the storage system, as well as the rate at which the solution is discharged to the turbine.

This invention offers different variants to facilitate its installation according to specific energy storage needs. This provides benefits in relation to the state of the art.

A variant of the invention includes a solute separator (e.g., a physical adsorption system) that retains the solute based on the pressure of the pressurized system. That is, the higher the pressure, the greater the solute retention in the separator. This separator is located after the pump to increase the solute storage capacity within the pressurized system (FIG. 3). In this way, during the charging stage a part of the solute will be stored in this separator, keeping the solute concentration in the solution at a lower value, and allowing a greater amount of solvent to pass through the semipermeable membrane. During the discharging stage, as the pressure decreases, the solute stored in the solute separator will go back into solution, allowing the higher osmotic pressure to be maintained and thus the total capacity of the system increases. In order to maximize the solute concentration in the solution that is in contact with the semipermeable separator, the solution must flow from reservoir B into the solute separator, and then pass through the semipermeable separator before being driven to the turbine. In the diagram shown in FIG. 3 this is depicted by keeping the valves V4 and V5 open, but keeping the valve V3 closed so that the solution in contact with the semipermeable separator has the highest possible solute concentration.

A second variant of the invention is one in which the same equipment functions as a pump during the charging stage and as a turbine during the discharging stage. This type of equipment is already used in PSH energy storage systems. The discharging stage of this variant is shown in FIG. 9. The operation is similar to the system explained above, with the difference that a different arrangement of the valves and pipes is required to conduct the liquid in the right direction, according to the stages described above.

Another variant of the invention includes the use of a compressible fluid that undergoes a change from gas to liquid phase during the charging stage. This gives the system an increase in energy storage density.

A fourth variant of the invention includes the use of solutions that are supersaturated or become supersaturated during the charging stage. This would allow the pressure in the pressurized system to be kept constant or almost constant during the discharging stage, increasing the efficiency of the turbine. However, it should be considered that this would add a risk of clogging due to the presence of a solid phase in the system that could clog the membranes or affect the normal operation of the turbine. While the above offers greater energy storage capacity, it could represent a higher cost in maintenance compared to the variants in which the solution is kept below its saturation point.

So far, a system has been described in which the liquid passing through the turbine is finally discharged into reservoir A, closing the circuit from the beginning of charging stage to the end of discharging stage. This scheme has the advantage of avoiding the possible introduction of impurities into the system at each charging cycle. However, a fifth variant of the invention is to have an open circuit in which the liquid solution passing through the turbine is not discharged into the same reservoir from which it was pumped during the charging stage. This variant could be utilized in locations with high-quality filtered liquid available, if this is an advantage for the user.

Another variant of the invention includes a compressor to supply and pressurize the compressible fluid to reservoir B. This compressor can be utilized before the first charging stage to establish the initial pressure at which the charging stage will begin. During normal system operation, this compressor can also be utilized to control the pressure of the pressurized system by means of a control loop that injects compressible fluid into reservoir B when the pressure sensor of the pressurized system detects that the pressure is falling to the minimum acceptable level. This provides greater storage capacity.

Finally, another variant of the invention is that in which the semipermeable separator is physically located within reservoir C below the liquid level of that reservoir. This facilitates the transfer of solvent mass from the pressurized system to the heart of reservoir C during the charging stage and vice versa during the discharging stage. In addition, by placing the semi-permeable separator within reservoir C, it is possible to reduce the total required surface area of the system. However, from the point of view of maintenance of the equipment, it is desirable to have easy access to it, so that in the preferred realization of the invention the semipermeable separator is an independent piece of equipment outside reservoir C.

All components of this system are known and available since long time ago, as they are common equipment in industries around the world, which reduces project development costs and avoids supply chain problems.

This system does not require unknown or exotic raw materials. Rather, the preferred fluids are water, air, and one or more of a variety of solutes, eliminating and decreasing several of the problems that disrupt the supply chain of other energy storage technologies, such as problems related to transporting raw materials over long distances, or the depletion of such materials.

Also, due to the reversible nature of the system, consumption is very low just to replace losses.

In relation to high-pressure reservoirs, in the present invention, the energy storage capacity per cubic meter of pressure vessel can be increased several times, depending on the solute chosen and the degree of saturation of the liquid solution.

This invention has some advantages similar to the advantages of PSH hydraulic energy storage systems. However, unlike a typical PSH system, this new invention does not have the geographical requirements such as a hill or some difference in height between two reservoirs.

Compared to the state of the art combining PSH and CAES, the advantage of the present invention is the increase in the energy storage capacity for a given volume and pressure of pressurized tanks, which are considered the most expensive element of this type of system. Additionally, by transferring liquid from the pressurized system to the low-pressure reservoir C during the charging stage, the rate at which compressible fluid is compressed in reservoir B during the charging stage is decreased. This slower compression rate gives more time to the compressible fluid to transfer its thermal energy to the liquid solution, keeping the process closer to an isothermal process compared to existing systems. In this way, lost work is minimized as the overall process is closer to an isothermal process.

In addition, the system is modular and easily scalable, covering a wide range of energy storage capacity simply by increasing the number of individual components.

### DESCRIPTION OF THE DRAWINGS

FIG. 1 shows the scheme of the process during the charging stage.

FIG. 2 shows the scheme of the process during the discharging stage.

FIG. 3 shows the variant of the invention including the solute separator after the pump.

FIG. 4 shows the osmotic pressure curve of the solution.

FIG. 5 shows the pressurized section of the system.

FIG. 6 shows the simplified scheme of reservoir A.

FIG. 7 shows the simplified scheme of reservoir B.

FIG. 8 shows the simplified scheme of reservoir C.

FIG. 9 shows the variant of the invention in which the same equipment is used as a pump during the charging stage and as a turbine during the discharging stage.

FIG. 10 shows the variant of the invention that includes a compressor to pressurize the compressible fluid from reservoir B.

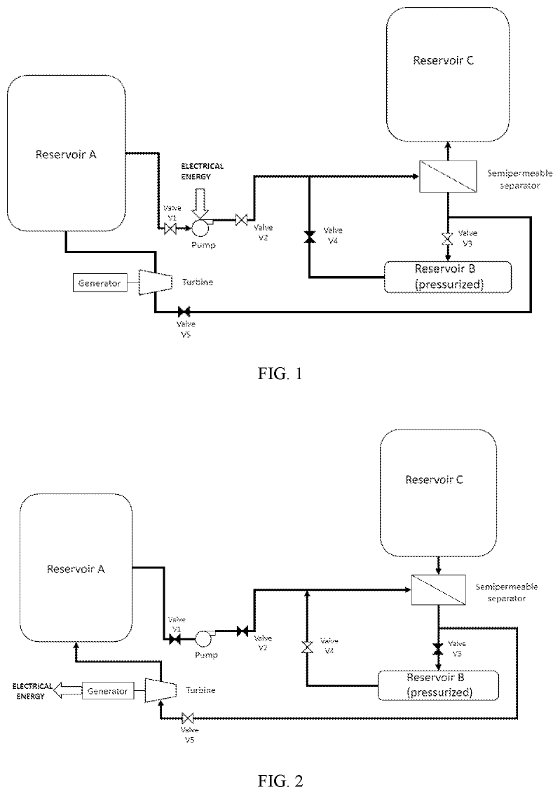

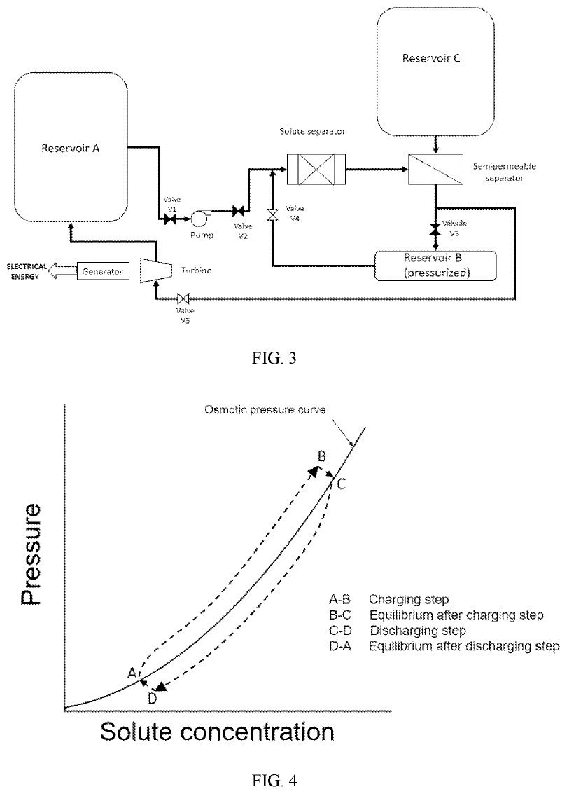

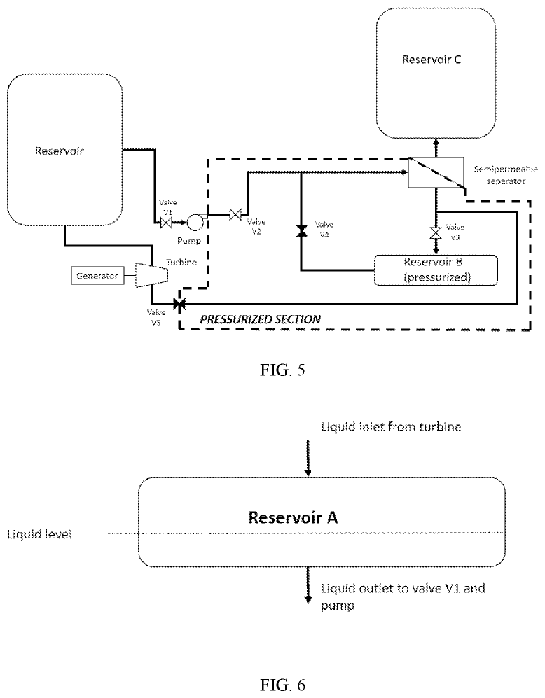

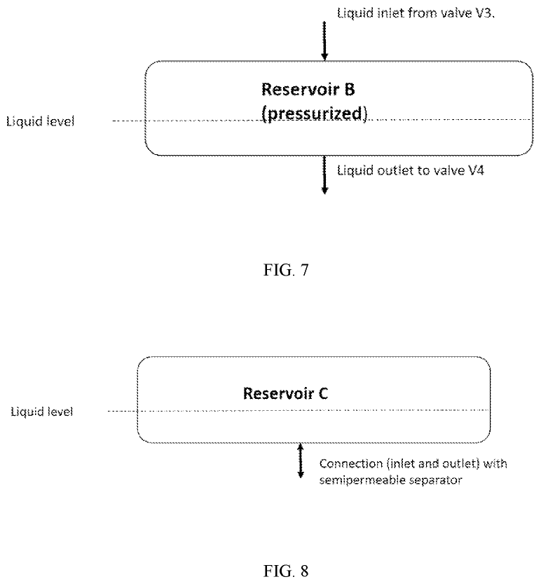

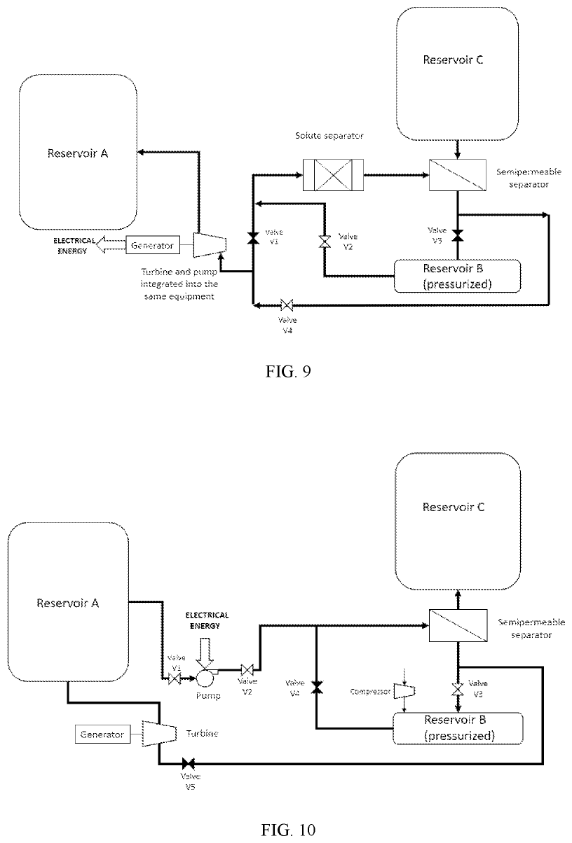

1. A system for the storage of energy by fluid compression and concentration difference in a liquid solution characterized by comprising: a reservoir (A) to store a liquid solution; a pressurized reservoir (B) to store a liquid solution and a compressible fluid; a reservoir (C) to store liquid; a pump; a semi-permeable separator; a turbine coupled to an electric power generator, in which the system is capable to store energy during the charging stage using an electrical energy input to energize a pump that drives the liquid solution from reservoir A to a higher-pressure reservoir B containing a compressible fluid, in which reservoir B is connected to a third reservoir C via a semipermeable separator that allows the solution to be separated into (1) a concentrated solution at higher pressure in reservoir B and (2) a liquid at lower pressure in reservoir C, where energy can be released during the discharging stage by driving the high-pressure liquid solution from reservoir B to a turbine connected to an electric power generator, and where the low-pressure liquid from reservoir C returns to the pressurized system due to its osmotic pressure, allowing both the liquid solution in reservoir B and the liquid in reservoir C to be utilized to generate electrical energy.

2. The system for the storage of energy by fluid compression and concentration difference in a liquid solution of claim 1 wherein the number of reservoirs A, B, or C may be increased for the purpose of increasing the storage capacity of the system.

3. The system for the storage of energy by fluid compression and concentration difference in a liquid solution of claim 1 in which the energy fed to the system is stored in the form of electrical energy.

4. The system for the storage of energy by fluid compression and concentration difference in a liquid solution of claim 1 wherein the energy within the system is released in the form of electrical energy.

5. The system for the storage of energy by fluid compression and concentration difference in a liquid solution of claim 1 wherein there is a solute separator between the pump and the semi-permeable separator to improve the separation in the semi-permeable separator.

6. The system for the storage of energy by fluid compression and concentration difference in a liquid solution of claim 1 wherein the solvent of the liquid solution is water.

7. The system for the storage of energy by compression of fluid and difference in concentration in a liquid solution of claim 1 wherein the compressible fluid is air.

8. The system for the storage of energy by fluid compression and concentration difference in a liquid solution of claim 1 wherein the liquid solution contained in reservoir A has more than one solute.

9. The system for the storage of energy by fluid compression and concentration difference in a liquid solution of claim 1 in which the same equipment functions as a pump during the charging stage and as a turbine during the discharging stage.

10. The system for the storage of energy by fluid compression and concentration difference in a liquid solution of claim 1 wherein the compressible fluid is a material that changes its physical phase in the system operating range.

11. The system for the storage of energy by fluid compression and concentration difference in a liquid solution of claim 1 wherein the liquid solution become supersaturated during the charging stage.

12. The system for the storage of energy by fluid compression and concentration difference in a liquid solution of claim 1 where the liquid solution is supersaturated since the beginning of the charging stage.

13. The system for the storage of energy by fluid compression and concentration difference in a liquid solution of claim 1 where, during the discharging stage, the liquid solution is discharged to a reservoir other than reservoir A after passing through the turbine.

14. The system for the storage of energy by fluid compression and concentration difference in a liquid solution of claim 1 in which a compressor is included to increase the pressure of the compressible fluid in reservoir B prior to the charging stage.

15. The system for the storage of energy by fluid compression and concentration difference in a liquid solution of claim 1 where the semi-permeable separator is located within reservoir C.

16. The system for the storage of energy by fluid compression and concentration difference in a liquid solution of claim 1 where pressurization by osmosis is utilized through the semi-permeable separator.

17. The system for the storage of energy by fluid compression and concentration difference in a liquid solution of claim 1 where no difference in the height of the water reservoirs is required.

18. The system for the storage of energy by fluid compression and concentration difference in a liquid solution of claim 1 where only one of the reservoirs is required to be pressurized.
